(19) United States
(12) Patent Application Publication
(10) Pub. No.: US 2010/0019831 A1
(43) Pub. Date: Jan. 28, 2010

(54) CHARGE PUMP USING LOW VOLTAGE CAPACITORS AND DDI COMPRISING THE CHARGE PUMP

(76) Inventor: Hee-seok Han, Hwaseong-si (KR)

Correspondence Address: F. CHAU & ASSOCIATES, LLC, 130 WOODBURY ROAD, WOODBURY, NY, 11797, US

(21) Appl. No.: 12/503,958

(22) Filed: Jul. 16, 2009

(30) Foreign Application Priority Data
Jul. 25, 2008 (KR) 10-2008-0072954

(51) Int. Cl. G05F 1/10

(52) U.S. Cl. 327/536

(57) ABSTRACT

A charge pump includes a first end including a first section having a first capacitor and a first node, and a second end including a second section having a second capacitor. The first section charges the first capacitor with a first voltage during a first logic section of a clock signal, and converts an external voltage to a first middle voltage using the first voltage and a second voltage in a second logic section of the clock signal. The first middle voltage is a node voltage of a first node. The second section is connected to the first node, charges the second capacitor with a third voltage during the first logic section of the clock signal, and converts the external voltage to an internal voltage by using the third voltage and the first middle voltage in the second logic section of the clock signal.

### CROSS-REFERENCE TO RELATED APPLICATIONS

This application claims priority to Korean Patent Application No. 10-2008-0072954, filed on Jul. 25, 2008, in the Korean Intellectual Property Office, the disclosure of which is incorporated herein by reference in its entirety herein.

### BACKGROUND

1. Technical Field

The present invention relates to a semiconductor device, and more particularly, to a charge pump that includes capacitors and a display driver IC (DDI) including the charge pump.

2. Discussion of Related Art

A charge pump may be considered a type of direct current (DC) to DC converter that uses capacitors as energy storage elements to create either a high or low voltage power source. The converter may use switching devices to control the connection of voltages to the capacitors. A charge pump can be used as a driver for a liquid crystal display (LCD) or a light emitting diode (LED), generating high bias voltages from a single low-voltage supply, such as a battery.

A DDI that drives an LCD that is mounted in a mobile device (e.g., a cell phone, handheld computer, etc.) may require a multitude of external components. The external components of the DDI may be formed of capacitors arranged in a charge pump that convert an external voltage to a voltage used in the DDI. The capacitors may be mounted in a DDI to lower the cost of an LCD module. However, the DDI may still consume a large amount of power and require a large layout surface area.

Thus, there is a need for a charge pump that consumes less power and a DDI that includes the charge pump that uses a smaller layout surface area.

### SUMMARY

A charge pump according to an exemplary embodiment of the present invention includes a first end having a first section and a second end having a second section. The first section includes a first capacitor and a first node. The first section is configured to charge the first capacitor with a first voltage during a first logic section of a clock signal, and convert an external voltage to a first middle voltage using the first voltage and a second voltage in a second logic section of the clock signal. The first middle voltage is a node voltage of the first node. The second section is connected to the first node and includes a second capacitor. The second section is configured to charge the second capacitor with a third voltage during the first logic section of the clock signal, and convert the external voltage to an internal voltage by using the third voltage and the first middle voltage in the second logic section of the clock signal.

The first capacitor and the third capacitor may have a same voltage. The first end and the second end may operate in synchronization. The first end may further include a third section that has a configuration that is symmetric to the first section and includes a third capacitor and a second node. The third section may be configured to charge the third capacitor with the first voltage during the second logic section of the clock signal, and convert the external voltage to a second middle voltage using the first voltage and the second voltage during the first logic section of the clock signal. The second middle voltage may be a node voltage of the second node.

The first section of the first end may include: first, second, third and fourth transistors. The first transistor may have a first terminal to which the first voltage is applied, and a second terminal connected to a first terminal of the first capacitor. A gate terminal of the first transistor may be connected to a first terminal of the third capacitor. The second transistor may have a first terminal connected to the second terminal of the first transistor and the first terminal of the first capacitor. A gate terminal of the second transistor may be connected to the gate terminal of the first transistor. The third transistor may have a first terminal connected to a second terminal of the first capacitor, and a second terminal connected to a ground voltage. The clock signal may be applied to a gate terminal of the third transistor. The fourth transistor may have a first terminal connected to the second terminal of the first capacitor, and a second terminal to which the second voltage is applied. The clock signal may be applied to a gate terminal of the fourth transistor.

The second end may further include a fourth section that has a configuration that is symmetric to the second section and may include a fourth capacitor. The fourth section may be connected to the second node, charge the fourth capacitor with the third voltage during the second logic section of the clock signal, and convert the external voltage into an internal voltage using the third voltage and the second middle voltage during the first logic section of the clock signal.

The second section of the second end may include: fifth, sixth, and seventh transistors. The fifth transistor may have a first terminal to which the third voltage is applied, and have a second terminal connected to a first terminal of the second capacitor. A gate terminal of the fifth transistor may be connected to a first terminal of the fourth capacitor. The sixth transistor may have a first terminal connected to the second terminal of the fifth transistor and the first terminal of the second capacitor, and a second terminal connected to the internal voltage. A gate terminal of the sixth transistor may be connected to the gate terminal of the fifth transistor. The seventh transistor may have a first terminal connected to a second terminal of the second capacitor and the first node, and a second terminal connected to a ground voltage. A clock signal may be applied to a gate terminal of the seventh transistor.

The first voltage and the second voltage may be the same as the external voltage, respectively. The first middle voltage may be twice greater than the external voltage. The third voltage may be the same as the external voltage. The internal voltage may be three times greater than the external voltage. The external voltage may be a positive voltage. Alternatively, the external voltage may be a negative voltage. Alternatively, the external voltage may be a ground voltage.

### BRIEF DESCRIPTION OF THE DRAWINGS

Exemplary embodiments of the present invention will be more clearly understood from the following detailed description taken in conjunction with the accompanying drawings in which:

FIGS. 1A and 1B are circuit diagrams of a charge pump according to an exemplary embodiment of the present invention;

FIG. 2 is a timing diagram illustrating the operation of the charge pump illustrated in FIG. 1 according to an exemplary embodiment of the present invention;

FIGS. 3A and 3B are circuit diagrams of a charge pump according to an exemplary embodiment of the present invention;

FIGS. 4A through 4C are circuit diagrams illustrating a charge pump according to an exemplary embodiment of the present invention that illustrates ends of the charge pump;

FIGS. 5A and 5B are circuit diagrams illustrating a charge pump according to an exemplary embodiment of the present invention; and

FIG. 6 is a schematic view illustrating a display driver IC (IC) according to an exemplary embodiment of the present invention.

### DETAILED DESCRIPTION OF THE EXEMPLARY EMBODIMENTS

Hereinafter, the present invention will be described in detail by explaining exemplary embodiments thereof with reference to the attached drawings. Like reference numerals in the drawings denote like elements.

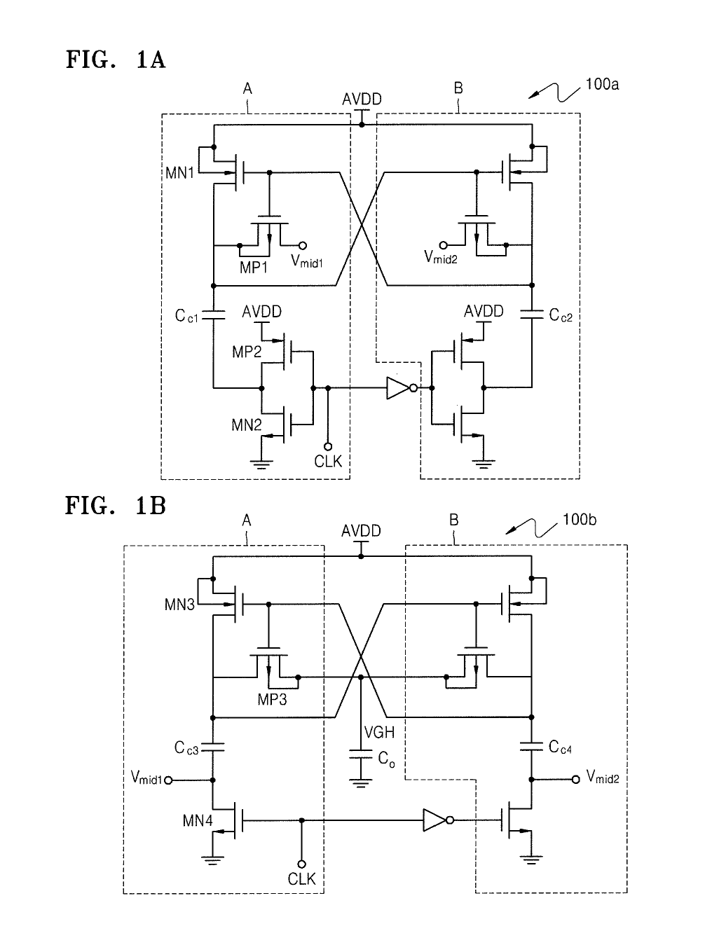

FIGS. 1A and 1B are circuit diagrams of a charge pump according to an exemplary embodiment of the present invention. Referring to FIGS. 1A and 1B, the charge pump converts an external voltage AVDD of about 5.5 V to an internal voltage VGH, which is about three times greater than the external voltage AVDD, to drive a display driver IC (DDI).

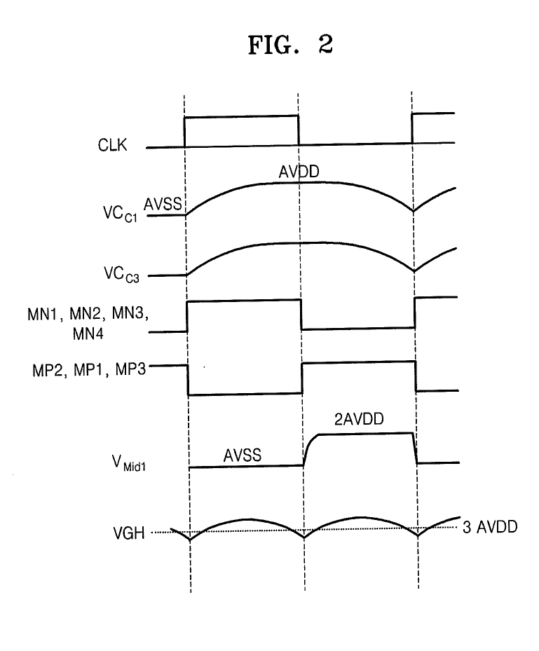

The charge pump includes a first end 100a illustrated in FIG. 1A and a second end 100b illustrated in FIG. 1B. A configuration and operation of the first end 100a of the charge pump according to an exemplary embodiment of the present invention will be described with reference to FIG. 1A and FIG. 2. Referring to FIG. 1A, the first end 100a of the charge pump includes a first section A having a first NMOS transistor MN1, a first PMOS transistor MP1, a first capacitor Cc1, a second NMOS transistor MN2, and a second PMOS transistor MP2, and a second section B having a configuration that is symmetric to the first section A. The first section A of the first end 100a is operated by a clock signal CLK applied to the first section A of the first end 100a. The second section B of the first end 100a is operated by an inverse signal of the clock signal CLK applied to the first section A of the first end 100a.

Accordingly, the second section B of the first end 100a operates in the same manner as the first section A of the first end 100a, except that a phase of the second section B is different from that of the first section A of the first end 100a (see FIG. 2). Thus, a description of the configuration and operation of the second section B of the first end 100a of the charge pump according to the current embodiment of the present invention is not necessary.

A first terminal of the first NMOS transistor MN1 is connected to an external voltage AVDD, and a second terminal of the first NMOS transistor MN1 is connected to a first terminal of the PMOS transistor MP1 and a first terminal of the first capacitor Cc1. A gate terminal of the first NMOS transistor MN1 is connected to a gate terminal of the first PMOS transistor MP1. A second terminal of the first PMOS transistor MP1 outputs a first middle voltage Vmid1.

The second NMOS transistor MN2 and the second PMOS transistor MP2 are serially connected between the external voltage AVDD and a ground voltage. The clock signal CLK is applied to each of the gate terminals of the second NMOS transistor MN2 and the second PMOS transistor MP2. A connection point between a terminal of the second NMOS transistor MN2 and a terminal of the second PMOS transistor MP2 is connected to a second terminal of the first capacitor Cc1.

FIG. 2 is a timing diagram of the operation of the charge pump of FIG. 1. Referring to FIGS. 1A and 2, the second NMOS transistor MN2 is turned on in response to the clock signal CLK at logic high H, and the first capacitor Cc1 is charged with the external voltage AVDD by the first NMOS transistor MN1 and the second NMOS transistor MN2. The first capacitor Cc1 is charged with the external voltage AVDD during the logic high H section of the clock signal CLK, and the first capacitor Cc1 is discharged during a logic low L section of the clock signal CLK.

The gate terminal of the first NMOS transistor MN1 is supplied a voltage of a second capacitor Cc2. As described above, the second section B of the first end 100a operates in the same manner as the first section A of the first end 100a, except that a phase of the second section B is different from that of the first section A. Accordingly, the second capacitor Cc2 is charged with the external voltage AVDD during a logic low L section of the clock signal CLK, and is discharged during a logic high H section of the clock signal CLK. Accordingly, the first NMOS transistor MN1 is turned on when the clock signal CLK is transitioned from a logic low L to a logic high H.

Further, referring to FIGS. 1A and 2, when the clock signal CLK is transitioned from a logic high H to a logic low L, the first PMOS transistor MP1 and the second PMOS transistor MP2 are turned on. The first PMOS transistor MP1 is turned on in the same manner as the first NMOS transistor MN1 described above.

When the first PMOS transistor MP1 and the second PMOS transistor MP2 are turned on, the external voltage AVDD connected to a first terminal of the second PMOS transistor MP2 is applied to the first middle voltage Vmid1. Charges charged in the first capacitor Cc1 from the external voltage AVDD during the logic high H section of the clock signal CLK are also applied to the first middle voltage Vmid1 during the logic low L section of the turned on clock signal CLK of the first PMOS transistor MP1. Accordingly, during the logic low L section of the clock signal CLK, the first middle voltage Vmid1 becomes about twice the external voltage AVDD.

As described above, the second section B of the first end 100a of the charge pump according to the current exemplary embodiment of the present invention has the same configuration as the first section A of the first end 100a of the charge pump and operates in the same manner as the first section A of the first end 100a of the charge pump. Thus, a second middle voltage Vmid2 is also increased to be about twice greater than the external voltage AVDD during the logic high H section of the clock signal CLK by a voltage charged in the second capacitor Cc2, which is substantially the same as the external voltage AVDD, and by the first and second PMOS transistors MP1 and MP2.

The first middle voltage Vmid1 is applied to the second end 100b of the charge pump according to the current embodiment. The configuration and operation of the second end 100b to which the first middle voltage Vmid1 is applied will be described with respect to FIG. 1B and FIG. 2.

Referring to FIG. 1B, the second end 100b of the charge pump according to an exemplary embodiment of the present invention includes a first section A having a third NMOS transistor MN3, a third PMOS transistor MP3, a third capacitor Cc3, and a fourth NMOS transistor MN4, and a second section B having a configuration that is symmetric to the first section A. The first section A of the second end 100b is operated by a clock signal CLK applied to the first section A of the second end 100b. The second section B is operated by an inverse signal of the clock signal CLK applied to the first section A of the second end 100b.

Consequently, the second section B of the second end 100b operates in the same manner as the first section A of the second end 100b, except that a phase of the second section B is different from that of the first section A. Thus, a description of the configuration and operation of the second section B of the second end 100b of the charge pump according to the current embodiment of the present invention is not necessary.

A first terminal of the third NMOS transistor MN3 is connected to an external voltage AVDD, and a second terminal of the third NMOS transistor MN3 is connected to a first terminal of the PMOS transistor MP3 and a first terminal of a third capacitor Cc3. A gate terminal of the third NMOS transistor MN3 is connected to a gate terminal of the third PMOS transistor MP3. A second terminal of the third PMOS transistor MP3 outputs the internal voltage VGH. A first middle voltage Vmid1 is applied between the third capacitor Cc3 and the fourth NMOS transistor MN4. The clock signal CLK is applied to a gate terminal of the fourth NMOS transistor MN4 and a second terminal of the fourth NMOS transistor MN4 is connected to a ground voltage.

Consequently, when the fourth NMOS transistor MN4 is turned on in response to the clock signal CLK at a logic high H, the third capacitor Cc3 is charged with the external voltage AVDD by the third NMOS transistor MN3 and the fourth NMOS transistor MN4.

The clock signal CLK of FIG. 1A and the clock signal CLK of FIG. 1B are synchronized. The first end 100a of FIG. 1A and the second end 100b of FIG. 1B operate in synchronization as illustrated in FIG. 2. For convenience of description, a delay that may be present between the first end 100a and the second end 100b is not illustrated in FIG. 2.

Referring to FIGS. 1A, 1B, and 2, the first capacitor Cc1 and the third capacitor Cc3 are charged while being synchronized to the same clock signal CLK, and the first through fourth NMOS transistors MN1 through MN4 are operated in synchronization. The first through third PMOS transistors MP1 through MP3 are also operated in synchronization.

Accordingly, when the third PMOS transistor MP3 is turned on, the internal voltage VGH can be generated to be about three times greater than the external voltage AVDD by the third capacitor Cc3, which is charged with the internal voltage VGH that is substantially the same as the external voltage AVDD and by the first middle voltage Vmid1, which is about twice greater than the external voltage AVDD applied from the first end 100a of the charge pump illustrated in FIG. 1A.

A voltage gain of the internal voltage VGH may be set to be about three times greater than the external voltage AVDD. For example, the DDI may operate at a high voltage of about 17 V, while the current external voltage AVDD is about 5.5 V. Further, the internal voltage VGH of the charge pump according to exemplary embodiments of the present invention are not limited to voltage gains that are about three times greater than the external voltage AVDD. For example, the internal voltage VHG may be set to a desired internal voltage according to various external voltages and voltage gains as will be described below.

The internal voltage VGH in FIG. 2 maintains a voltage of about 3*AVDD, regardless of the logic level of a clock signal CLK because the second sections B of the first and second ends 100a and 100b operate in the same manner as the first sections A in different logic level sections of the clock signal CLK than those of first sections A of the first and second ends 100a and 100b. For example, during the logic low L section of the clock signal CLK, the internal voltage VGH of 3*AVDD is generated according to the operation of the first section A, and during the logic high H section of the clock signal CLK, the internal voltage VGH of 3*AVDD is generated according to the operation of the second section B.

The internal voltage VGH that is generated according to the above-described configuration and operation, which is about three times greater than the external voltage AVDD, may be applied to the DDI via an external capacitor Co.

The capacitors of the charge pump according to the current exemplary embodiment of the present invention are charged with a voltage less than an external voltage, and thus each of the capacitors has an internal voltage corresponding to the external voltage. The capacitance per unit surface area of the capacitors is increased as the internal voltage of the capacitors is decreased. The internal voltage of the capacitors is proportional to a distance between electrodes at both ends of the capacitors because the capacitance is inversely proportional to the distance.

Accordingly, the electric power efficiency of the charge pump according to the current exemplary embodiment of the present invention can be increased without using a switch for discharging, and its layout surface area can be reduced using capacitors with low internal voltages.

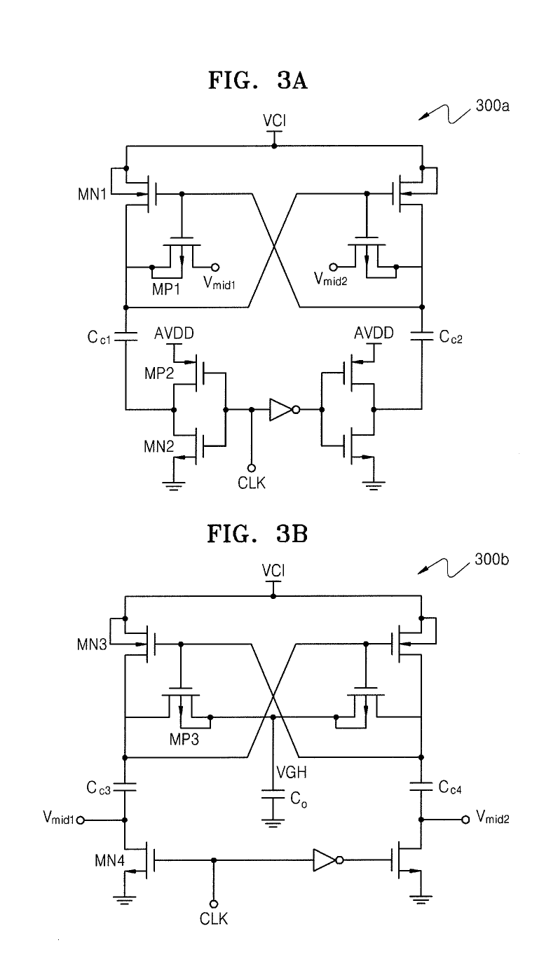

FIGS. 3A and 3B are circuit diagrams illustrating a charge pump according to an exemplary embodiment of the present invention. Referring to FIGS. 3A and 3B, a first end 300a and a second end 300b of the charge pump have the same configurations as the first end 100a and the second end 100b of the charge pump of FIG. 1, and conduct the same operations. However, an external voltage VCI of the charge pump may be about 2.7 V, whereas the external voltage AVDD of FIG. 1 is about 5.5 V. In the charge pump, an internal voltage VGH is 1.5*AVDD instead of 3*AVDD as in the charge pump of FIG. 1.

Although an external voltage that is half the external voltage of the charge pump of FIG. 1 is applied to the charge pump of FIGS. 3A and 3B, the size of the external voltage is not limited thereto, and thus various external voltages may be applied. Thus, according to the charge pumps of exemplary embodiments of the present invention, a voltage gain can vary by varying the size of the applied external voltage without changing the internal voltage of the capacitors forming the charge pumps.

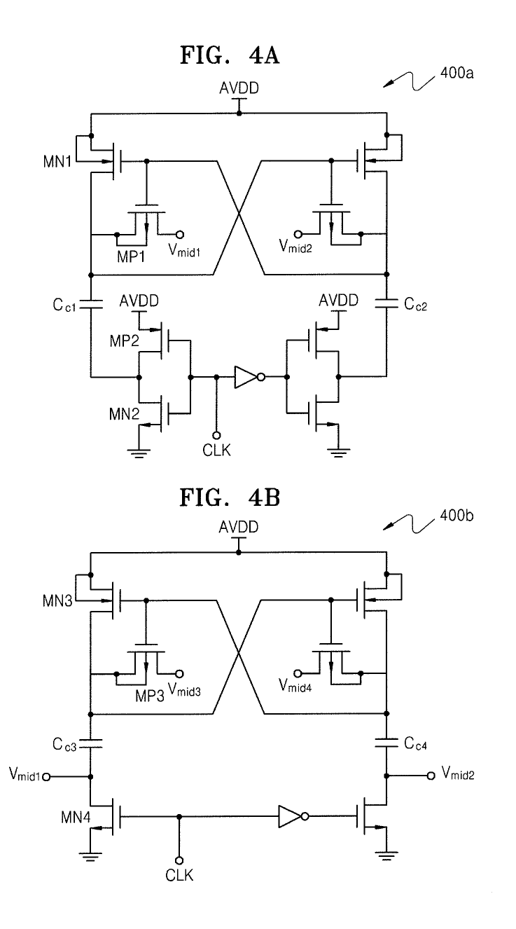

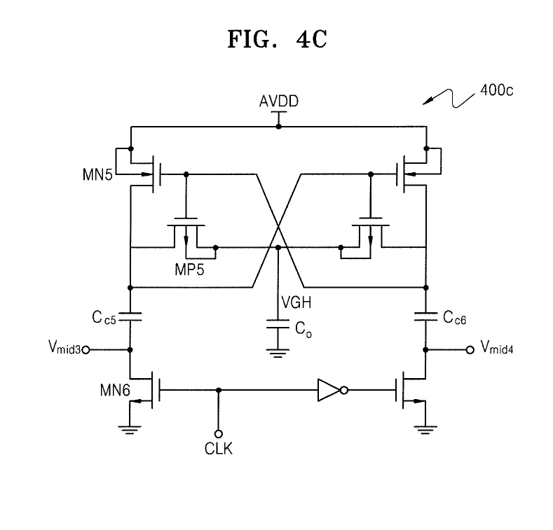

FIGS. 4A through 4C are circuit diagrams illustrating a charge pump according to an exemplary embodiment of the present invention. Referring to FIGS. 4A through 4C, the charge pump includes first through third ends 400a through 400c, unlike the charge pump of FIGS. 1A and 1B that includes the first end 100a and the second end 100b. In the charge pump, middle voltages of 400*AVDD of the second end 400b are generated, and an internal voltage VGH of 5*AVDD is generated.

While the charge pump of FIGS. 4A through 4C has a three-end structure, embodiments of the present invention are not limited thereto, as the charge pump may have four ends or more. For example, according to the charge pumps of exemplary embodiments of the present invention, a voltage gain can vary by varying the number of ends of the charge pumps 400 without changing the internal voltage of the capacitors that form the charge pumps 400.

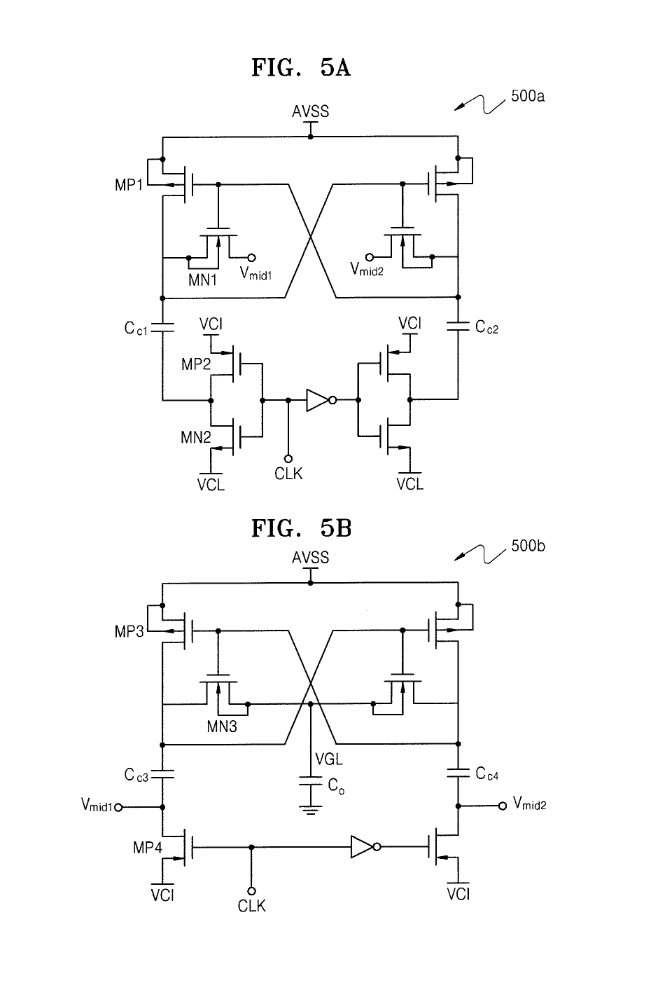

FIGS. 5A and 5B are circuit diagrams illustrating a charge pump according to an exemplary embodiment of the present invention. Referring to FIGS. 5A and 5B, the charge pump generates a negative internal voltage VGL. First and second ends 500a and 500b of the charge pump of FIGS. 5A and 5B have similar configurations and operate in a similar manner as the charge pumps 100, 300, and 400 according to the previous embodiments. However, while the charge pumps 100, 300, and 400 according to the previous embodiments generate a positive internal voltage VGH, the charge pump of FIGS. 5A and 5B generates a negative voltage VGL and thus a ground voltage AVSS may be applied to the charge pump of FIGS. 5A and 5B. However, exemplary embodiment of the present invention are not limited thereto, as a predetermined negative voltage VCL may also be applied, wherein the predetermined negative voltage VCL may be about −2.7 V.

Further, transistors of the charge pump of FIGS. 5A and 5B are of different types than the transistors of the charge pumps 100, 300, and 400 according to the previous embodiments. For example, first through fourth PMOS transistors MP1 through MP4 of FIGS. 5A and 5B correspond to the first through fourth NMOS transistors MN1 through MN4 of FIGS. 1A and 1B. In the same manner, first through third NMOS transistors MN1 through MN3 of FIGS. 5A and 5B correspond to the first through third PMOS transistors MP1 through MP3 of FIGS. 1A and 1B.

The generation of an internal voltage of the charge pump of FIGS. 5A and 5B is described as follows. As the first PMOS transistor MP1 and the second PMOS transistor MP2 are turned on, a first capacitor Cc1 is charged with a voltage −VCI. The voltages VCI and VCL may have the same magnitude but have different signs. For example, the VCL may be a voltage of about −2.7 V, and the VCI may be a voltage of about +2.7 V.

When the logic level of the clock signal CLK is transitioned and the first NMOS transistor MN1 and the second NMOS transistor MN2 are turned on, then a first middle voltage Vmid1 is generated as −VCL+VCI, which is twice the size of the negative voltage VCL. The second middle voltage Vmid2 is the same as the first generated middle voltage Vmid1.

The first middle voltage Vmid1 and the second middle voltage Vmid2 generated according to the first end 500a are applied to the second end 500b. Like the charge pump of FIGS. 1A and 1B, the charge pump of FIGS. 5A and 5B may also be operated while the first end 500a and the second end 500b are in synchronization. Accordingly, during the logic high H section of the clock signal CLK, the negative internal voltage VGL becomes 3*VCL (=−3*VCL) by a third capacitor Cc3, which is charged with VCL (=−VCL) and by the first middle voltage Vmid1 of 2*VCL (=−2*VCL).

When a negative voltage that is different from a ground voltage AVSS is applied to the first PMOS transistor MP1 and the third PMOS transistor MP3, a more negative internal voltage VGL may be generated.

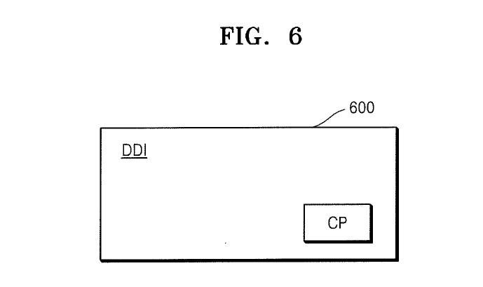

FIG. 6 is a schematic view illustrating a DDI 600 according to an exemplary embodiment of the present invention. Referring to FIG. 6, the DDI 600 includes the charge pump illustrated in FIGS. 1A and 1B, FIGS. 3A and 3B, FIGS. 4A, 4B, and 4C, and FIGS. 5A, and 5B and generates an internal voltage to drive the DDI 600. In an alternate embodiment, the DDI 600 may include one of the charge pumps of FIGS. 1A and 1B, FIGS. 3A and 3B, and FIGS. 4A, 4B, and 4C, that generate a positive internal voltage and the charge pump of FIGS. 5A, and 5B that generates a negative internal voltage.

While charge pumps of the exemplary embodiments of the present invention discussed above include a first section and a second section having a structure symmetric to the other, exemplary embodiments of the present invention are not limited thereto. For example, charge pumps according to exemplary embodiments of the present invention may include only a first section or only a second section.

For example, an exemplary embodiment of the present invention only includes the first end 100 of FIG. 1A. In this example, the gate terminal of the first NMOS transistor MN1 and the gate terminal of the first PMOS transistor MP1 of the first end 100a of FIG. 1A are connected to a clock signal CLK and gated according to a logic level of the clock signal CLK. This also applies to the gate terminals of the third NMOS transistor MN3 and the third PMOS transistor MP3.

According to at least one embodiment of the present invention, the charge pumps of a DDI are formed of capacitors having low internal voltages, and thus the electric power efficiency of the DDI may be increased and its layout surface area may be reduced. Thus, performance of the DDI may be improved and manufacturing costs can be reduced, thereby obtaining price competitiveness.

While the present invention has been particularly shown and described with reference to exemplary embodiments thereof, it will be understood by those of ordinary skill in the art that various changes in form and details may be therein without departing from the spirit and scope of the disclosure.

What is claimed is:

1. A charge pump comprising:
a first end comprising a first section, the first section comprising a first capacitor and a first node, wherein the first section is configured to charge the first capacitor with a first voltage during a first logic section of a clock signal, and convert an external voltage to a first middle voltage by using the first voltage and a second voltage during a second logic section of the clock signal, wherein the first middle voltage is a node voltage of the first node; and
a second end comprising a second section and a second capacitor, the second section connected to the first node, wherein the second section is configured to charge the second capacitor with a third voltage during the first logic section of the clock signal, and convert the external voltage to an internal voltage by using the third voltage and the first middle voltage in the second logic section of the clock signal.

2. The charge pump of claim 1, wherein the first capacitor and the second capacitor have a same voltage.

3. The charge pump of claim 1, wherein the first end and the second end operate in synchronization.

4. The charge pump of claim 1, wherein the first end further comprises a third section that has a configuration symmetric to the first section and includes a third capacitor and a second node, and the third section is configured to charge the third capacitor with the first voltage during the second logic section of the clock signal, and convert the external voltage to a second middle voltage by using the first voltage and the second voltage during the first logic section of the clock signal, wherein the second middle voltage is a node voltage of the second node.

5. The charge pump of claim 4, wherein the first section of the first end comprises:
a first transistor having a first terminal to which the first voltage is applied, and a second terminal connected to a first terminal of the first capacitor, wherein a gate terminal of the first transistor is connected to a first terminal of the third capacitor;
a second transistor having a first terminal connected to the second terminal of the first transistor and the first terminal of the first capacitor, wherein a gate terminal of the second transistor is connected to a gate terminal of the first transistor;
a third transistor having a first terminal connected to a second terminal of the first capacitor, and a second terminal connected to a ground voltage, wherein the clock signal is applied to a gate terminal of the third transistor; and
a fourth transistor having a first terminal connected to the second terminal of the first capacitor, and a second terminal to which the second voltage is applied, wherein the clock signal is applied to a gate terminal of the fourth transistor.

6. The charge pump of claim 4, wherein the second end further comprises a fourth section that has a configuration that is symmetric to the second section and includes a fourth capacitor, wherein fourth section is connected to the second node, charges the fourth capacitor with the third voltage during the second logic section of the clock signal, and converts the external voltage into an internal voltage using the third voltage and the second middle voltage during the first logic section of the clock signal.

7. The charge pump of claim 6, wherein the second section of the second end comprises:
a fifth transistor having a first terminal to which the third voltage is applied, and having a second terminal connected to a first terminal of the second capacitor, wherein a gate terminal of the fifth transistor is connected to a first terminal of the fourth capacitor;
a sixth transistor having a first terminal connected to the second terminal of the fifth transistor and the first terminal of the second capacitor, and a second terminal connected to the internal voltage, wherein a gate terminal of the sixth transistor is connected to a gate terminal of the fifth transistor; and
a seventh transistor having a first terminal connected to a second terminal of the second capacitor and the first node, and a second terminal connected to a ground voltage, wherein a clock signal is applied to a gate terminal of the seventh transistor.

8. The charge pump of claim 1, wherein the first voltage and the second voltage are the same as the external voltage, respectively.

9. The charge pump of claim 8, wherein the first middle voltage is twice greater than the external voltage.

10. The charge pump of claim 8, wherein the third voltage is the same as the external voltage.

11. The charge pump of claim 10, wherein the internal voltage is three times greater than the external voltage.

12. The charge pump of claim 1, wherein the external voltage is a positive voltage.

13. The charge pump of claim 1, wherein the external voltage is a negative voltage or a ground voltage.

14. A display driver IC (DDI) comprising a charge pump, wherein the charge pump comprises:
a first end comprising a first section, the first section comprising a first capacitor and a first node, wherein the first section is configured to charge the first capacitor with a first voltage during a first logic section of a clock signal, and convert an external voltage to a first middle voltage by using the first voltage and a second voltage during a second logic section of the clock signal, wherein the first middle voltage is a node voltage of the first node; and
a second end comprising a second section and a second capacitor, the second section connected to the first node, wherein the second section is configured to charge the second capacitor with a third voltage during the first logic section of the clock signal, and convert the external voltage to an internal voltage by using the third voltage and the first middle voltage in the second logic section of the clock signal.

15. The DDI of claim 14, wherein the first capacitor and the second capacitor have a same voltage.

16. The DDI of claim 1, wherein the first end and the second end operate in synchronization.

17. A charge pump comprising:
an i-th end that includes an i-th capacitor and an i-th node, wherein the i-th end is configured to charge the i-th capacitor with an external voltage during a first logic section of a clock signal, and convert the external voltage to an i-th middle voltage using the i-th capacitor and the external voltage in a second logic section of the clock signal, wherein the i-th middle voltage is a node voltage of the i-th node and i is a natural number;
a j-th end that includes a j-th capacitor and j-th node, wherein the j-th end is connected to the i-th node, charges the j-th capacitor with the external voltage during the first logic section of the clock signal, and converts the external voltage to a j-th middle voltage using the j-th capacitor and the i-th middle voltage in the second logic section of the clock signal, wherein the j-th middle voltage is a node voltage of the j-th node; and
an N-th end that includes an N-th capacitor, wherein the N-th end is connected to the j-th node, charges the N-th capacitor with the external voltage during the first logic section of the clock signal, and converts the external voltage to an internal voltage by using the N-th capacitor and the j-th middle voltage in the second logic section of the clock signal, wherein N is a natural number greater than i and j, and j=i+1.

18. The charge pump of claim 17, wherein the i-th capacitor, the j-th capacitor, and the N-th capacitor have a same voltage.

19. The charge pump of claim 17, wherein the i-th end, the j-th end, and the N-th end operate in synchronization with one another.

20. The charge pump of claim 17, wherein the internal voltage is 2(N−1)+1 times greater than the external voltage.
